(19) United States
(12) Patent Application Publication
(10) Pub. No.: US 2020/0300002 A1
(43) Pub. Date: Sep. 24, 2020

(54) MULTI-FACTOR PHYSICALLY UNCLONABLE FUNCTION KEY, COIN, OR RFID

(71) Applicant: LEXMARK INTERNATIONAL, INC., LEXINGTON, KY (US)

(72) Inventors: SCOTT RICHARD CASTLE, LEXINGTON, KY (US); GARY ALLEN DENTON, LEXINGTON, KY (US); JAMES PAUL DRUMMOND, GEORGETOWN, KY (US); KEITH BRYAN HARDIN, LEXINGTON, KY (US); KELLY ANN KILLEEN, LEXINGTON, KY (US); ROBERT HENRY MUYSKENS, LEXINGTON, KY (US); BRANT DENNIS NYSTROM, LEXINGTON, KY (US)

(21) Appl. No.: 16/823,621

(22) Filed: Mar. 19, 2020

Related U.S. Application Data
(60) Provisional application No. 62/822,541, filed on Mar. 22, 2019.

(51) Int. Cl. E05B 47/00; E05B 19/26; E05B 19/00; E05B 17/10; E05B 17/22

(52) U.S. Cl. CPC E05B 47/0045; E05B 19/26; E05B 17/22; E05B 17/103; E05B 19/0052

(57) ABSTRACT

The invention relates generally a device that authenticates a user, operator, or object using multiple factors, thus decreasing the likelihood of unauthorized use. These factors preferably are independent from each other and difficult to defeat. By combining a mechanical key with a number of physically unclonable functions (PUF), the resulting system may be impossible to duplicate or defeat. The addition of the PUF can be deployed to mechanical keys or RFID's of different types without reducing the functionality of the first factors operation.

### CROSS REFERENCES TO RELATED APPLICATIONS

U.S. patent application Ser. No. 16/823,615, titled “Tamper-Proof Physical Unclonable Function Seals for Authentication of Bottles.”

### PRIORITY CLAIM FROM PROVISIONAL APPLICATION

The present application is related to and claims priority under 35 U.S.C. 119(e) from U.S. provisional application No. 62/822,541, filed Mar. 22, 2019, titled “Tamper-Proof PUF Seals for Authentication of Bottles,” the content of which is hereby incorporated by reference herein in its entirety.

### BACKGROUND

One of the oldest forms of object authentication is a mechanical key and lock system. This is a single factor system that relies solely on mechanical shape of the key. One form of a two-factor system is a key with a security Integrated Circuit (IC) found in automotive systems. It has been repeatedly proven these systems can be defeated if enough effort is applied. Various forms of IC keys have been expanded to radio frequency identification (RFID) which can also be defeated or copied. It has also been shown that increasing the number of authentication factors that are, in themselves difficult to defeat, creates a much higher security system. There is a need for ever-increasing difficult and number of factors to authenticate data, things, or people's identities.

### SUMMARY

The present disclosure relates generally a device that authenticates a user, operator, or object using multiple factors, thus decreasing the likelihood of unauthorized use. These factors are preferably independent from each other and difficult to defeat. By combining a mechanical key with a number of physically unclonable functions (PUF), the resulting system may be impossible to duplicate or defeat. The addition of the PUF can be deployed to mechanical keys or RFID's of different types without reducing the functionality of the first factors operation.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings.

FIG. 1A shows a mechanical key with PUF for multifactor authentication with a sensor read area along the side of the key.

FIG. 1B shows a mechanical key with PUF for multifactor authentication and a rigid low wear material added outside the PUF material contained within the key.

FIG. 1C show a mechanical key with PUF for multifactor authentication with sensor read areas starting at the tip and along the cuts.

FIG. 2 shows a key core mechanical lock pins and magnetic PUF reader.

FIG. 3 magnetic field presented to PUF reader device.

FIG. 4 shows a cylindrical key containing a PUF factor.

FIG. 5A shows a multiple factor PUF matrix material.

FIG. 5B shows a cross section of a multiple factor PUF matrix material.

FIG. 6A shows a low frequency RFID tag with integrated PUF matrix material.

FIG. 6B shows a UHF linear tag with integrated PUF matrix material.

FIG. 6C shows a UHF circular polarized tag with integrated PUF matrix material.

FIG. 7 shows a PUF matrix material with accessible wire contacts.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having,” and variations thereof herein is meant to encompass the items listed thereafter and equivalents thereof as well as additional items.

Terms such as “about” and the like have a contextual meaning, are used to describe various characteristics of an object, and such terms have their ordinary and customary meaning to persons of ordinary skill in the pertinent art. Terms such as “about” and the like, in a first context mean “approximately” to an extent as understood by persons of ordinary skill in the pertinent art; and, in a second context, are used to describe various characteristics of an object, and in such second context mean “within a small percentage of” as understood by persons of ordinary skill in the pertinent art.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Spatially relative terms such as “top,” “bottom,” “front,” “back,” “rear,” and “side,” “under,” “below,” “lower,” “over,” “upper,” and the like, are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc., and are also not intended to be limiting. Like terms refer to like elements throughout the description.

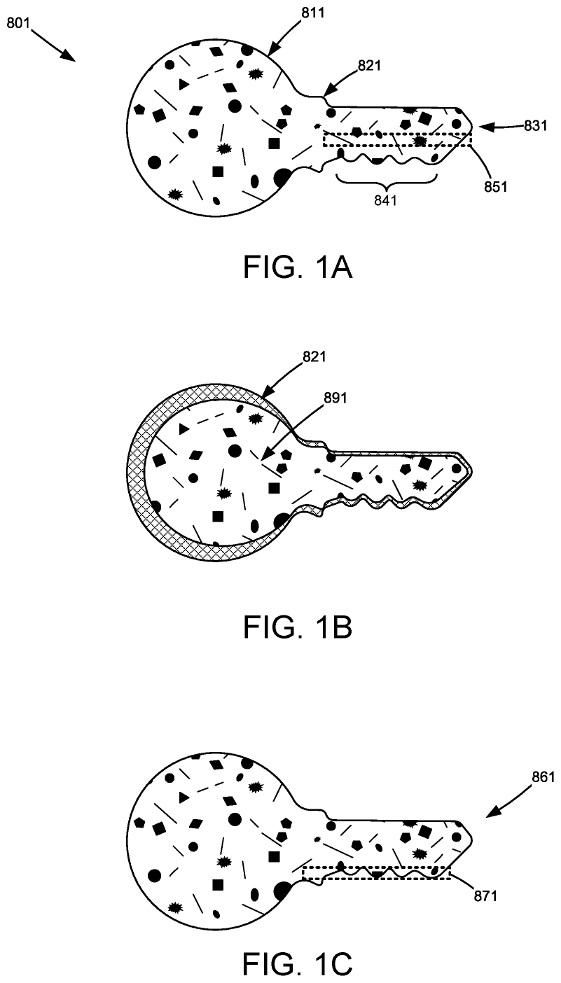

This invention integrates a mechanical key function with a physically unclonable function to provide a multi-faceted or multi-factor authentication system. FIG. 1A shows a magnetic matrix with a key shape 801. The base key is composed from a matrix material of pre-magnetized or post-magnetized flakes in a nonmagnetic base material. The shape of the material is then molded or cut into a key shape as shown in FIGS. 1A, 1B, and 1C. The elements of the key shape 801, the bow 811, the shoulder 821, the tip 831, the cuts 841, a sensor read area along the side of the key 851 combined with the pin position information, which may be further combined with sensor read areas starting at the tip 861, and along the cuts 871 shown in FIG. 1C, all contributing to the authentication process.

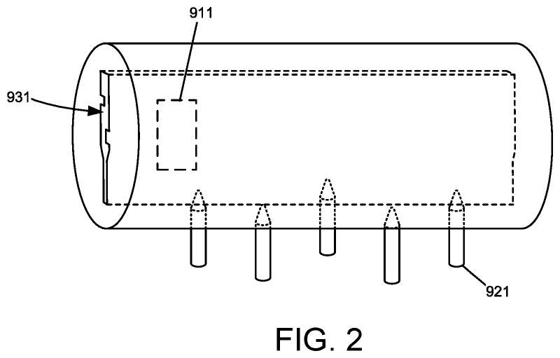

The first authentication is the shape of the key where the mechanical cuts must correspond to the enrolled key element. The second level, or factor, authentication is the magnetic fields at the tip 831 and along the region 851 that create a unique magnetic pattern. An electronic magnetometer reader 911 located within the core keyway shown in FIG. 2 that reads along one 851 or more surfaces, measuring the magnetic field orientation and magnitude, provides an authentication measure. This magnetic pattern is random with pre-magnetized or post-magnetized magnetic flakes or a predetermined deterministic magnetic pattern that was previously disclosed in U.S. Pat. No. 10,212,300, titled “Magnetic Keys Having a Plurality of Magnetic Plates,” the content of which is hereby incorporated by reference herein in its entirety.

The base material of this implementation is a thermoplastic polymer such as an acrylic base resin. In that case it would exhibit some wear over extended use. Other thermoplastic polymers such as nylon, polyketone, or polycarbonate would be more durable. To construct a key for durability it could contain glass or carbon fibers, silica, metals, or other materials for reinforcement. The metals would need to be non-magnetic or soft ferrites that would not retain magnetic field.

An alternative to dispersing wear resistant materials within the key would be to combine a PUF area within a low wear key material. FIG. 1B shows a rigid low wear material 821 with the perimeter of the PUF material 891 contained within the key. One skilled in the art would understanded that the interior area with the PUF material may be any arbitrary shape. The PUF material may also be completely contained within an interior cavity within the key. This configuration could have a portion of the cover be very thin and non-magnetic material to allow the PUF magnetic field to penetrate the surface.

FIG. 2 shows a magnetic reader with mechanical cut detection in the form of a pin tumbler. Here, a magnetometer 911 is embedded with mechanical lock pins 921 to detect the cut areas of the key. The insertion of the key into the slot 931 guides the magnetic flakes along a predetermined path across the magnetometer that gives a unique fingerprint. The sensor read area in FIGS. 1A and 1C, will result in a three-dimensional (“3D”) magnetic field values along the read path that will be unique for each key. The combination of the two factors means that each key is unique and can be correlated to the cut pattern of the key. The combination of the mechanical key and magnetometer becomes an electronic reader device.

The reader may also incorporate switches, potentiometers, or optical devices to determine the pin locations to give feedback on the key insertion. This additional sensing would allow predetermined user insertion methods to be used to add complexity. For example, the key may be inserted to the full depth and then retracted a predetermined number of detents before inserting again. This additional action of complexity can be used to deter misuse of a key that has been stolen.

For additional security, magnetometers can be placed on both sides of the slot at different heights.

An additional embodiment is can be considered by making the key thick enough that a third magnetometer may be added along the top edge. The key cross section is preferred to be rectangular as shown but any cross section would be functional and would give a unique class of key. A cross section that was rotationally symmetric would allow the key to be inserted in different directions. Part of the security would be that the operator knows in advance what direction the key needs to be inserted to operate the lock, or if multiple insertions in a specific order are required, the operator may know in advance the required order for authentication.

A circular cross section would allow the key to be inserted in any direction. It could also be rotated both during insertion and when fully inserted. This would give an additional security feature that would only be known by the operator. The user can have a predetermined actuation patterns for rotation. This would include clockwise and counterclockwise motions or angles of stop like a combination lock. This will allow multiple users to have different levels of access by the knowledge of the pattern using the same object or PUF device.

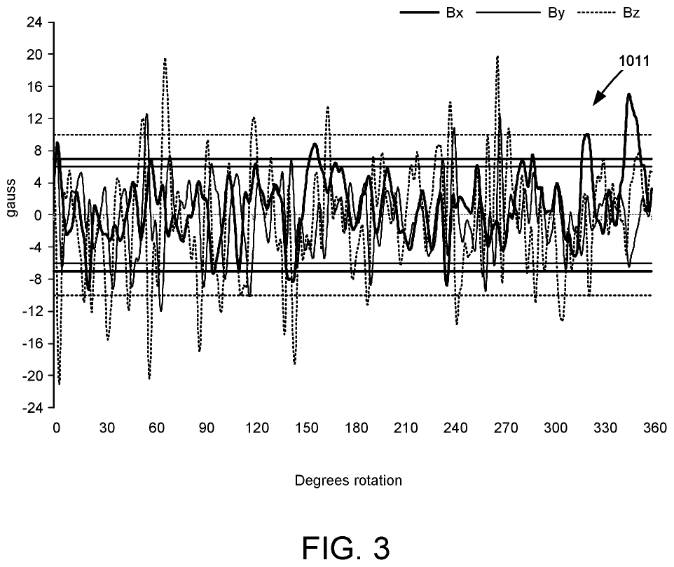

As the key is inserted into the channel the 3D magnetic field varies in amplitude as is shown in FIG. 3, for example. FIG. 3 shows a three-dimensional field as read by each magnetometer. The X axis is labeled at the “Degrees rotation” for a cylindrical rotation of the key. This axis could instead be the distance that a key is inserted into a core as shown is in FIG. 2.

The reading system would verify both the mechanical cut locations and magnetic field before actuating the lock of system. The magnetic field signature would then give the unique key identification.

There may be an authentication measure that depends upon the insertion speed of the key. It is desirable, for example, to confirm that the key has been fully inserted and to measure the velocity of the insertion. Another embodiment is to have two 3D magnetometers placed close to each other in the direction of key travel. The separation of the magnetometers should be just less than half the average flake size. This will result in two spatially shifted magnetic field patterns that can be used to calculate the velocity and relative position of the key, thus resulting in greater security.

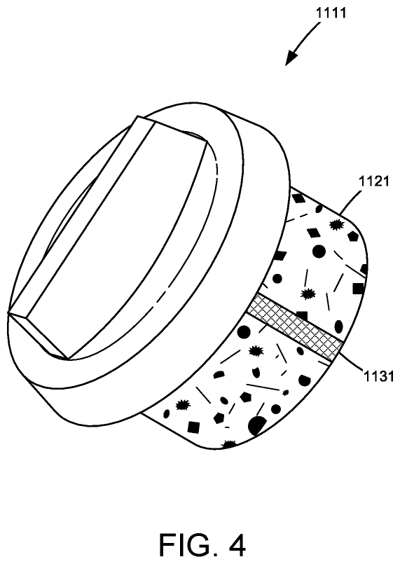

Another embodiment of the PUF key system would incorporate a rotationally actuated key with cylindrical features which allows the reading of the key as it is rotated about the axis of the cylinder. In this design, the magnetometer(s) would be located radially from the key position and read a circumference of the key as the key is rotated, or in an alternate form, the magnetometer may be rotated to perform the read operation. The key may be pushed into a mating feature to the point where a switch is activated, thus initiating the reading of the key. In this way, some mechanical features in the key may also be used as a second factor needed for insertion. In a similar embodiment, a cylindrical key may be envisioned where the magnetic PUF material is on the circular tip of a cylindrical key. In this embodiment, the reader may be located in a manner where it can read the tip of the key as it is rotated in a mating key slot, or it could make a static read of the key tip. FIG. 4 show one design for a cylindrical key 1111 containing a PUF 1121, with or without a divider 1131 in the PUF.

An additional authentication factor would take advantage of the optical characteristics that are inherent in the PUF material used in the examples presented. One material that may be used in FIGS. 1A, 1B, and 1C is an alloy of neodymium, iron, and boron (NdFeB), which is opaque with a shiny surface. An optical sensing system that measures the transmission through the key or the reflectivity would be very random in nature, giving an optical signature to compare against. This is achieved with a single source of light emission and a single point receiving device. These devices are orientated on the same side of the key for reflectivity and opposite side for transmission. A single or diffused light source can be used with a 2D camera to read an area of transmitted or reflected light resulting is a high density of data for the higher security system. A line scanning camera, or other similarly operable device, can also be used.

The optical system previously described operates by using the magnetic particles to block or reflect light with an optically transparent media for the matrix material. An additional embodiment would be to add optical wave guiding material to channel the light from one location to another. This is achieved by introducing optical transparent fibers into the matrix. The fibers may be composed of any material that can withstand the molding and extrusion process with the magnetic particles. The preferred material would be glass fibers that have a melting temperature much greater that the matrix base material.

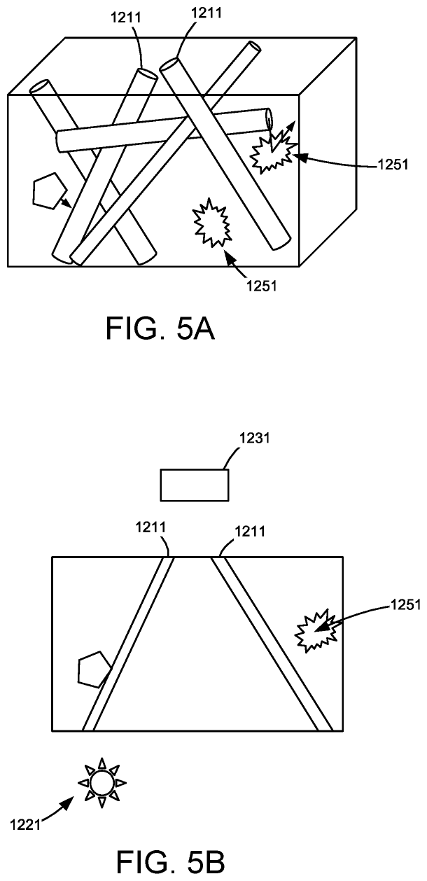

The fiber lengths should be randomized so that the travel distance would be unknown. The matrix base material can be optically opaque or transparent. FIG. 5A shows an illustrative 3D drawing of the resulting material with a 2D cross section shown in FIG. 5B. Shown is a combination magnetic particles 1251 and glass fiber 1211 matrix (FIG. 5A) with a cross-section (FIG. 5B), identify the optical fibers 1211, the position of the light source 1221, and the position of the light sensor 1231.

The optical fiber will translate the light through the matrix in a different pattern. With a transparent matrix base material, the transmitted light 1221 will be the result of all possible transmitted direct, reflective and blocked paths. If base material is opaque, then only the fiber paths through the matrix will transmit light from one side to the other. It also understood that the fibers may be serpentine in shape so light may be translated from a surface through the material and out the same surface that the light entered.

Particles that are reflective to UV or other light sources that are fluorescent may be added in the matrix and read by a selective light sensor.

The addition of the optical fiber to the magnetic PUF material may alleviate the need for the mechanical key portion authentication device. In FIG. 1A, the round section resembles a coin shape. The application of the magnetic or optical PUF could be applied to any coin currency or wagering token for casinos. Currently the state of the art includes radio-frequency identification (“RFID”) techniques within a coin. Today the level of security for integrated circuit chip counterfeiting has proven that most electronic system can be duplicated maliciously. The magnetic and optical fiber PUF can augment the RFID functionality. The coin or object can also be patterned with a company's logo embossed, printed, etched, or otherwise attached to the surface.

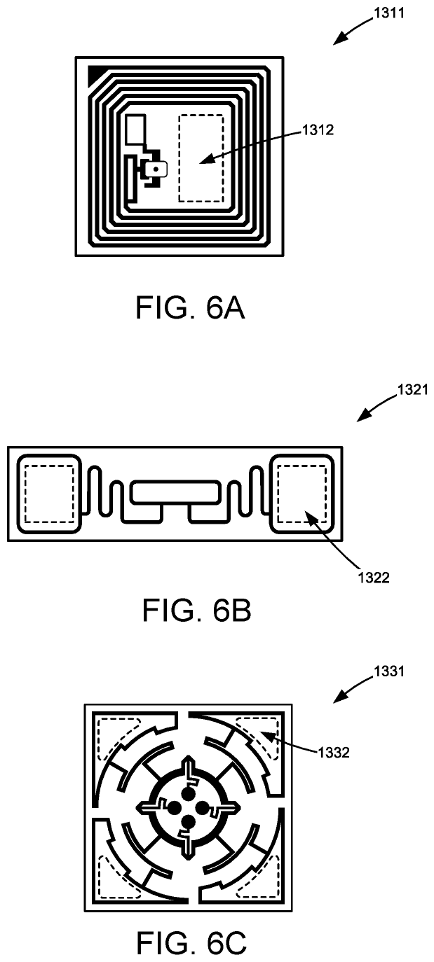

RFID tags range in antenna geometry for the frequency range of use. Typically, low frequency tags below 100 MHz are magnetically coupled tags. For these tags, material with a magnetic permeability will interfere with the tag operation if not properly located. The alloys of neodymium, iron, and boron (NdFeB) or samarium and cobalt (SmCo) particles that are preferred to be pre-magnetized to saturation do not exhibit a high relative permeability. This allows the addition of the PUF matrix material in the regions marked by the dashed areas in FIG. 6A for a low frequency tag 1311, dashed area 1312, a UHF linear tag 1321 (FIG. 6B), dashed area 1322, and a UHF circular polarized tag 1331 (FIG. 6C), dashed area 1332.

The magnetic particles are conductive so that they can change the transmission line characteristics if they can bridge the conductor loops or antenna sections. The open areas or the conductive top load sections are the areas that will not affect the tag operation.

For any PUF device, there is a challenge with the density of the data needed for characterizing and performing a match to guarantee the sensed information matches some predetermined enrollment data. The data, if very dense, requires a significant amount of memory. For the keys shown in FIGS. 1A, 1B, and 1C, each flake creates an array of field values in three-dimensions. Finding a match between a stored pattern and sensor measurement would require excessive computation time to go through all the patterns in a database to find the match to a key. An indexing method can be used to extract features from a key to quickly reduce the number of possible matches. For example, FIG. 3 shows the magnetic field along the line 851 of the key in FIG. 1A. The dashed lines 1011 are set at 50% of the peak value of each of the three field directions. An algorithm can be created that counts the number of instances that each field value transitions outside of the dashed lines. For this example, Bx=10, By=16, and Bz=21. This algorithm can have some error issues when the signal level is very close to peaking near the threshold. This could mean that the count could have a positive or negative error, so the index may need to be searched to each count with a hysteresis tolerance. This is a linear example. If the PUF data is read over an area, then the problem becomes a 2D surface plot.

There is a problem if many PUF devices have the same index range causing many different enrolled profiles to be within the range of possible matches. There are at least two potential solution paths. In one, the algorithm needs to parse all possible PUF devices so that there is a wide distribution of index values. The second solution path is to create the PUF devices with materials that will result in a wide distribution of index values for a given algorithm.

Described below are various methods to create features within a PUF device to construct index variables of different kinds.

In a large particle method, the flake size is created by using sifting screens to bracket ranges of material. The distribution of sizes can be controlled to result in an index value. The loading of each flake size with non-uniform distributions can be used as digits of a number. For example, if the flake sizes were limited to ranges of 800 um-1000 um, 200 um-400 um and below 100 um then a count of flakes in each size range could be a digit of a 3-number index. The loading of different densities of each of the particle ranges would distribute the index values.

In a displacement method, a mix of dielectric material or nonmagnetic material with large particle sizes can be used to displace pre-magnetized particles causing gaps in the field values resulting in minima index values. The material used would not melt during the forming of the PUF object which would on allow the creation of voids in the magnetic field that could also be turned into an index.

As previously discussed, a logo may be added as a displacement to the PUF material. Logos may be etched, painted or applied to the surface.

Creating a mechanical fiducial by punching holes can result in an index value on magnetic field minima or mechanically measuring the index. The holes may be punched or laser cut. A laser can also be used to etch the surface of the object to encode the index as a number, count of patches including size and shape variations.

In a checker board overlay method, the technique is to overlay a predefined grid to divide the PUF material different areas. Each cell within the grid is analyzed by one of the methods listed to create an index for each cell. The array can then be matched by rotating the data for a total of 4 translations assuming the reader probe is aligned to two of the four sides of a square. Each area can then be analyzed to create the index number to speed the lookup of the pattern within a database. Many different methods can be used to create the index number for the cell. These are discussed below.

In the inflection count method, the inflection count is the number of inflections, i.e., where the second derivative is zero.

The sign count method is the number of times a signal transitions between opposite signs.

The rate of increase, the number of signal segments that have a positive or negative slope change could be determined.

In the local maxima method, there is a count of the number of local maxima locations.

In the local minima method, there is a count of the number of local minima locations.

The average value in an area method finds the average value in a predetermine area.

It understood by one skilled in the area that all of the methods above can be used to find a distance between these features to create an index. Each can be used in a one- or two-dimesions. The location can be in rectangular (X and Y) or circular (r and theta) units.

One of multi-factor could be reflective, absorbing or transmissive with incident ‘light’ being beyond human visual (e.g. hyperspectral, multi-spectral, IR, UV). Detection means possibly coupled with band-pass filtering of reflection/transmission.

One example, a resin with magnetic particles where resin contains taggants that fluoresce visibly when excited by UV, but occlusions of magnetic particles that create one channel of an optical PUF. Multi-factor identification accomplished with magnetic and optical signature.

The 3D magnetic field patterns (FIG. 3) or algorithmic analyses described above could further be used to generate/verify a cryptographic key to encode the transfer of information for electronic locking mechanisms. These concepts could also be expanded beyond the realm of physical locking mechanisms to electronic systems. For example, many of the embodiments described above could be used to create a physical key that could be used as second factor authentication for access to computer systems and/or information stored electronically.

In another method, transferring the anchor key into and out of a block chain data set may access a crypto currency. In this embodiment an object has a key number that the block chain describes a value to the object for currency or any other negotiable value. The key and value may be read and then assigned a new value depending on the transaction. The PUF key/object may also be used as a tangible/physical manifestation of a cryptocurrency wallet ID/key.

The sensor method for the embedded wire PUF material can be made by time domain reflectometry or spectrum sweep. This can be done my having a one or more ports probes on the surface of the substrate. A one port measurement would have two conductive pads in close proximity to the surface of the substrate. This would capacitively couple the stimulus into the matrix of wires. Each path would cause reflections to vary the response. Each location on the surface would give a different response. An additional embodiment is to expose two or more wires to the surface of the matrix allowing a conductive pad to be applied to the wire giving a repeatable probe location. A two-port measurement would find the transmission characteristic between different locations on the surface.

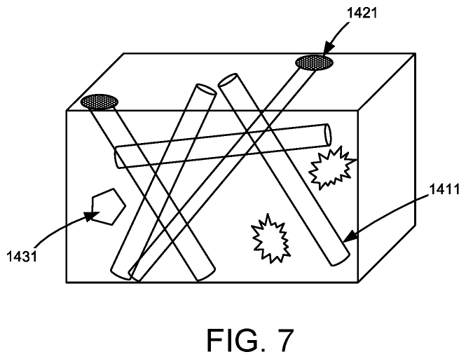

FIG. 7 shows two matrix materials, magnetic and glass or carbon fibers, silica, metals, or other 1431, with conducting wire segments 1411 imbedded within the object. In FIG. 7 the probing method requires a capacitive interface to the object since the surface may not have any exposed connection points. In FIG. 7 a material is plated on to the surface that makes connection 1421 to some individual wire segments. This can be done by several manufacturing methods. The surface may be abraded to expose a connection out and then a platting material could be added or painted to the surface making a port.

The reader device can may be a standalone device or work by using a phone to interface to the reader. The communication methods would include Bluetooth, hardwire, or NFC for two-way communications. The reader can create a magnetic field close to the phones magnetometer to communicate to the phone. The phone light or screen could optically communicate to the reader device. Security between the phone and reader device would be critical. All the communication would need to be encrypted by some method to subvert a man in the middle attack between the reader and external device.

The foregoing description of embodiments has been presented for purposes of illustration. It is not intended to be exhaustive or to limit the present disclosure to the precise steps and/or forms disclosed, and obviously many modifications and variations are possible in light of the above teaching. It is intended that the scope of the invention be defined by the claims appended hereto.

We claim:

1. A multi-factor authentication system comprising:
a base key that contains a matrix material of pre-magnetized flakes in a nonmagnetic base material, wherein the the material is molded or cut into a key-shape; and
an electronic magnetometer reader located within a core keyway to read the tip or along one or more surfaces of the key shape that measures the magnetic field orientation and magnitude of the pre-magnetized flakes.

2. The system of claim 1, wherein the base material of the key is an acrylic.

3. The system of claim 1, wherein the pre-magnetized flakes contain an alloy of neodymium, iron, and boron.

4. The system of claim 1, wherein the pre-magnetized flakes contain an alloy of samarium and cobalt.

5. The system of claim 2, wherein the key contains glass fibers, carbon fiber, silica, or non-magnetic metals for reinforcement.

6. The system of claim 1, wherein the perimeter of the matrix material of pre-magnetized flakes is within a rigid low-wear material.

7. The system of claim 6, wherein a thin cover of the rigid low-wear material is on the surface of the key.

8. A magnetic reader device with mechanical cut detection in a pin tumbler comprising:
a magnetometer embedded in the pin tumbler;
mechanical lock pins;
a slot to guide the insertion of the key;
one or more magnetometer sensors to read the three-dimensional magnetic field at the tip of the key;
one or more magnetometer sensors to read the three-dimensional magnetic field along one or both sides of the key; and
one or more magnetometer sensors to read the three-dimensional magnetic field along the cuts of the key.

9. The reader device of claim 8, wherein switches, potentiometers, or optical devices are incorporated to determine the pin locations to give feedback on the key insertion.

10. The reader device of claim 8, wherein one or more magnetometer sensors read the three-dimensional magnetic field along the top of the key.

11. A multi-factor authentication system comprising:
a rotationally actuated key with cylindrical features that contain a magnetic physical unclonable function material in the form of pre-magnetized flakes in a nonmagnetic base material, where the cylindrical shape allows the reading of the key as it is rotated about the axis of the cylinder; and
an electronic magnetometer reader located within a cylindrical keyway to read the tip or sides of the cylindrical key shape, which measures the magnetic field orientation and magnitude of the pre-magnetized flakes.

12. The system of claim 11, wherein the electronic magnetometer reads the tip and sides of the cylindrical key shape.

13. The system of claim 11, wherein the pre-magnetized flakes contain an alloy of neodymium, iron, and boron.

14. The system of claim 11, wherein the pre-magnetized flakes contain an alloy of samarium and cobalt.

15. A multi-factor authentication system comprising:
a key that contains a physical unclonable function (PUF) matrix material of pre-magnetized flakes in a nonmagnetic base material, wherein the the material is molded or cut into a key-shape;
an electronic magnetometer reader located within a core keyway to read the tip or along one or more surfaces of the key shape that measures the magnetic field orientation and magnitude of the pre-magnetized flakes;
a single source of light emission within the core keyway to illuminate the key; and
a single point optical sensing system that measures the light transmission through the key or the reflectivity.

16. The system of claim 15, wherein optical transparent fibers are added to the matrix.

17. The system of claim 16, wherein the fibers are glass.

18. The system of claim 15, wherein non-magnetic particles that are reflective to UV or other light sources that are fluorescent are added to the matrix.

19. The system of claim 15, wherein the base material of the key is an acrylic.

20. The system of claim 15, wherein the pre-magnetized flakes contain an alloy of neodymium, iron, and boron.
